(19) United States
(12) Patent Application Publication
(10) Pub. No.: US 2014/0228480 A1
(43) Pub. Date: Aug. 14, 2014

(54) VEHICLE TYRE, THE TREAD OF WHICH COMPRISES A HEAT-EXPANDABLE RUBBER COMPOSITION

(71) Applicants: Yu Shiraishi, Chiyoda-ku (JP); Olivia Cuscito, Clermont-Ferrand (FR)

(72) Inventors: Yu Shiraishi, Chiyoda-ku (JP); Olivia Cuscito, Clermont-Ferrand (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/122,394

(22) PCT Filed: May 31, 2012
(86) PCT No.: PCT/EP2012/060216

§ 371 Date: Feb. 21, 2014

(30) Foreign Application Priority Data
Jun. 1, 2011 (FR) 1154799

(51) Int. Cl. C08L 9/06

(52) U.S. Cl. CPC C08L 9/06
USPC 523/156

(57) ABSTRACT

A vehicle tyre includes a tread formed of a rubber composition that is heat-expandable when unvulcanized, and expanded when vulcanized. When unvulcanized, the composition includes from 50 to 100 phr of a copolymer based on styrene and butadiene; optionally from 0 to 50 phr of another diene elastomer, such as a polybutadiene or a natural rubber; more than 50 phr of a reinforcing filler, such as silica and/or carbon black; between 5 and 25 phr of a sodium- or potassium-including carbonate or hydrogencarbonate; and between 2 and 15 phr of a carboxylic acid having a melting point between 60° C. and 220° C., such as citric acid. A total content of the carboxylic acid and the carbonate or the hydrogencarbonate is greater than 10 phr. Presence of the carboxylic acid and the carbonate or the hydrogencarbonate makes it possible to significantly reduce noise emitted by the tyre during running.

### 1. FIELD OF THE INVENTION

The invention relates to tyres for motor vehicles and to the rubber compositions which can be used for the manufacture of such tyres.

It relates more particularly to tyres, the tread of which comprises a foam rubber composition, in the vulcanized state, intended to reduce the noise emitted by these tyres during the running of the vehicles

### 2. STATE OF THE ART

It is known (see, for example, Patent Application WO 2010/069510) that the noise emitted by a tyre when running originates, inter alia, from the vibrations of its structure resulting from the contact of the tyre with the irregularities of the roadway, also bringing about generation of various sound waves. Everything is ultimately manifested in the form of noise, both inside and outside the vehicle. The amplitude of these various manifestations depends on the modes of vibration specific to the tyre and also on the nature of the surface on which the vehicle is moving. The range of frequencies corresponding to the noise generated by the tyres typically extends from 20 to 4000 Hz approximately.

As regards the noise noticed inside the vehicle, two methods of propagation of the sound coexist:
the vibrations are transmitted via the wheel centre, the suspension system and the transmission in order to finally generate noise in the passenger compartment; reference is then made to “structure-borne transmission”, which is generally dominant for low frequencies of the spectrum (up to approximately 400 Hz);
the sound waves emitted by the tyre are directly propagated by the aerial route within the vehicle, the latter acting as filter; reference is then made to “aerial transmission”, which generally dominates in the high frequencies (approximately 600 Hz and above).

The noise referred to as “road noise” instead describes the overall level of noise noticed in the vehicle and within a frequency range extending up to 2000 Hz. The noise referred to as “cavity noise” describes the nuisance due to the resonance of the inflation cavity of the casing of the tyre.

As regards the noise emitted outside the vehicle, the various interactions between the tyre and the road surface, and the tyre and the air, which will be a nuisance for the occupants of the vehicle when the latter rolls over a roadway, are relevant. In this case, several sources of noise, such as the noise referred to as “indentation noise”, due to the impact of the rough patches of the road in the contact area, the noise referred to as “friction noise”, essentially generated on exiting the contact area, and the noise referred to as “pattern noise”, due to the arrangement of the pattern elements and to the resonance in the various grooves, are distinguished. The range of frequencies concerned typically corresponds here to a range extending from 300 to 3000 Hz approximately.

### 3. BRIEF DESCRIPTION OF THE INVENTION

In point of fact, the Applicant Companies have discovered, during their research studies, a specific rubber composition which, incorporated in the tread of the tyres, has improved sound barrier properties within a frequency range located between 30 and 2000 Hz and is thus capable of contributing to reducing the noise emitted both inside and outside the vehicles during the running of their tyres.

Consequently, the present invention relates to a tyre, the tread of which comprises, in the non-vulcanized state, a heat-expandable rubber composition comprising at least:
from 50 to 100 phr of a copolymer based on styrene and butadiene;
optionally from 0 to 50 phr of another diene elastomer;
more than 50 phr of a reinforcing filler;
between 5 and 25 phr of sodium carbonate, sodium hydrogencarbonate, potassium carbonate or potassium hydrogencarbonate;
between 2 and 15 phr of a carboxylic acid, the melting point of which is between 60° C. and 220° C.;
the total content of (hydrogen)carbonate and carboxylic acid being greater than 10 phr.

The invention also relates to a tyre, in the vulcanized state, obtained after curing (vulcanizing) the raw tyre in accordance with the invention as described above.

The tyres of the invention are particularly intended to equip motor vehicles of passenger type, including 4×4 (four-wheel drive) vehicles and SUV (Sport Utility Vehicles) vehicles, two-wheel vehicles (in particular motorcycles), and also industrial vehicles chosen in particular from vans and heavy-duty vehicles (i.e., underground trains, buses and heavy road transport vehicles, such as lorries or tractors).

The invention and its advantages will be readily understood in the light of the description and the implementational examples which follow.

### 4. DETAILED DESCRIPTION OF THE INVENTION

In the present description, unless expressly indicated otherwise, all the percentages (%) shown are percentages by weight.

“Diene” elastomer (or, without distinction, rubber) is understood to mean an elastomer resulting at least in part (that is to say, a homopolymer or a copolymer) from diene monomer(s) (i.e., monomers carrying two conjugated or non-conjugated carbon-carbon double bonds). “Isoprene elastomer” is understood to mean an isoprene homopolymer or copolymer, in other words a diene elastomer selected from the group consisting of natural rubber (NR), synthetic polyisoprenes (IRs), various isoprene copolymers and the mixtures of these elastomers.

The abbreviation “phr” means parts by weight per hundred parts of elastomer (of the total of the elastomers, if several elastomers are present).

Furthermore, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The tyre of the invention thus has the essential characteristic that its tread, in the non-vulcanized state, at the very least for its portion (radially outermost part) intended to come directly into contact with the surface of the road, comprises a heat-expandable rubber composition comprising at least:
from 50 to 100 phr of a (at least one, that is to say one or more) copolymer based on styrene and butadiene;
optionally from 0 to 50 phr of a (at least one, that is to say one or more) other diene elastomer;
more than 50 phr of a (at least one, that is to say one or more) reinforcing filler;
between 5 and 25 phr of (at least one of, that is to say one or more of) sodium carbonate, sodium hydrogencarbonate, potassium carbonate or potassium hydrogencarbonate;
between 2 and 15 phr of a (at least one, that is to say one or more) carboxylic acid, the melting point of which is between 60° C. and 220° C.;
the total content of (hydrogen)carbonate and carboxylic acid being greater than 10 phr.

The various components above are described in detail below.

4.1. Copolymer Based on Styrene and Butadiene

The first essential characteristic of the heat-expandable rubber composition is to comprise from 50 to 100 phr of a copolymer based on styrene and butadiene, that is to say of a copolymer of at least one styrene monomer and of at least one butadiene monomer; in other words, the said copolymer based on styrene and butadiene comprises, by definition, at least units resulting from styrene and units resulting from butadiene.

Preferably, the content of the said copolymer in the heat-expandable rubber composition is within a range from 50 to 90 phr, more preferably within a range from 60 to 85 phr.

The following are suitable in particular as butadiene monomers: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, or an aryl-1,3-butadiene. The following are suitable in particular as styrene monomers: styrene, methylstyrenes, para(tert-butyl)styrene, methoxystyrenes or chlorostyrenes.

The said copolymer based on styrene and butadiene can have any microstructure, which depends on the polymerization conditions used, in particular on the presence or absence of a modifying and/or randomizing agent and on the amounts of modifying and/or randomizing agent employed. It can, for example, be a block, random, sequential or microsequential copolymer and can be prepared in dispersion or in solution; it can be coupled and/or star-branched or else functionalized with a coupling and/or star-branching or functionalization agent.

Preferably, the copolymer based on styrene and butadiene is selected from the group consisting of styrene/butadiene copolymers (abbreviated to SBRs), styrene/butadiene/isoprene copolymers (abbreviated to SBIRs) and the mixtures of such copolymers. Mention may in particular be made, among the SBIR copolymers, of those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2- plus 3,4-units of the isoprene part of between 5% and 70% and a content (mol%) of trans-1,4-units of the isoprene part of between 10% and 50%.

More preferably, an SBR copolymer is used. Mention may in particular be made, among the SBR copolymers, of those having a styrene content of between 5% and 60% by weight and more particularly between 20% and 50%, a content (mol%) of 1,2-bonds of the butadiene part of between 4% and 75%, and a content (mol%) of trans-1,4-bonds of between 10% and 80%.

The Tg of the copolymer based on styrene and butadiene is preferably greater than −40° C., more preferably greater than −35° C. and in particular between −30° C. and +30° C. (more particularly within a range from −25° C. to +25° C.).

The Tg of the elastomers described here is measured in a conventional way well known to a person skilled in the art on an elastomer in the dry state (i.e., without extending oil) and by DSC (for example according to ASTM D3418-1999).

A person skilled in the art knows how to modify the microstructure of a copolymer based on styrene and butadiene, in particular of an SBR, in order to increase and adjust its Tg, in particular by varying the contents of styrene, of 1,2-bonds or also of trans-1,4-bonds of the butadiene part. Use is more preferably made of an SBR (solution or emulsion) having a styrene content (mol %) which is greater than 35%, more preferably between 35% and 60%, in particular within a range from 38% to 50%. SBRs having a high Tg are well known to a person skilled in the art; they have been used essentially in tyre treads in order to improve some of their wear properties.

The above copolymer based on styrene and butadiene can be combined with at least one other (also referred to as second) diene elastomer, other than the said copolymer (that is to say, not comprising units resulting from styrene and butadiene), the said second diene elastomer being present at a content by weight which is consequently at most equal to 50 phr.

This optional second diene elastomer is preferably selected from the group consisting of natural rubbers (NRs), synthetic polyisoprenes (IRs), polybutadienes (BRs), isoprene copolymers and the blends of these elastomers. Such copolymers are more preferably selected from the group consisting of isoprene/butadiene copolymers (BIRs) and isoprene/styrene copolymers (SIRs).

Among the latter, polybutadiene homopolymers (BRs), in particular those having a content (mol%) of 1,2-units of between 4% and 80% or those having a cis-1,4-content (mol %) of greater than 80%; polyisoprene homopolymers (IRs); butadiene/isoprene copolymers (BIRs), in particular those having an isoprene content of between 5% and 90% by weight and a Tg of from −40° C. to −80° C.; isoprene/styrene copolymers (SIRs), in particular those having a styrene content of between 5% and 50% by weight and a Tg of between −25° C. and −50° C., are suitable in particular.

According to a preferred embodiment, the second diene elastomer is an isoprene elastomer, more preferably natural rubber or a synthetic polyisoprene of the cis-1,4-type; use is preferably made, among these synthetic polyisoprenes, of polyisoprenes having a content (mol %) of cis-1,4-bonds of greater than 90%, more preferably still of greater than 98%.

According to another preferred embodiment, the second diene elastomer is a polybutadiene, preferably a polybutadiene having a content of cis-1,4-bonds of greater than 90%.

According to another preferred embodiment, the second diene elastomer is a mixture of polybutadiene with an isoprene elastomer (natural rubber or synthetic polyisoprene).

More preferably, the content of second diene elastomer, in particular of polybutadiene and/or isoprene elastomer (in particular natural rubber), is within a range from 10 to 50 phr, more preferably still within a range from 15 to 40 phr.

The diene elastomers described above might also be combined, in a predominant amount, with synthetic elastomers other than diene elastomers, indeed even polymers other than elastomers, for example thermoplastic polymers.

4.2. Filler

Use may be made of any filler known for its capabilities in reinforcing a rubber composition, for example an organic filler, such as carbon black, or else an inorganic filler, such as silica, with which is combined, in a known way, a coupling agent.

Such a filler preferably consists of nanoparticles, the (weight-)average size of which is less than a micrometre, generally less than 500 nm, most often between 20 and 200 nm, in particular and more preferably between 20 and 150 nm.

Preferably, the content of total reinforcing filler (especially silica or carbon black or a mixture of silica and carbon black) is between 50 and 150 phr. A content of greater than 50 phr promotes good mechanical strength; beyond 150 phr, there exists a risk of excessive stiffness of the rubber composition. For these reasons, the content of total reinforcing filler is more preferably within a range from 70 to 120 phr.

Suitable as carbon blacks are, for example, all carbon blacks which are conventionally used in tyres (“tyre-grade” blacks), such as carbon blacks of the 100, 200 or 300 series (ASTM grades), such as, for example, the N115, N134, N234, N326, N330, N339, N347 or N375 blacks. The carbon blacks might, for example, be already incorporated in the diene elastomer, in particular isoprene elastomer, in the form of a masterbatch (see, for example, Application WO 97/36724 or WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

“Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, especially silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will be made, as highly dispersible precipitated silicas (HDSs), for example, of the Ultrasil 7000 and Ultrasil 7005 silicas from Degussa, the Zeosil 1165MP, 1135MP and 1115MP silicas from Rhodia, the Hi-Sil EZ150G silica from PPG or the Zeopol 8715, 8745 and 8755 silicas from Huber.

According to another particularly preferred embodiment, use is made, as predominant filler, of a reinforcing inorganic filler, in particular silica, at a content within a range from 70 to 120 phr, to which reinforcing inorganic filler can advantageously be added carbon black at a minor content at most equal to 15 phr, in particular within a range from 1 to 10 phr.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

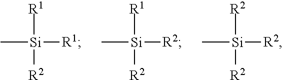

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R², radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl)polysulphides. Use is made in particular, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or US 2004/051210) and WO 2007/061550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of silanes bearing at least one thiol (—SH) function (referred to as mercaptosilanes) and/or at least one masked thiol function, such as described, for example, in patents or patent applications U.S. Pat. No. 6,849,754, WO 99/09036, WO 2006/023815 and WO 2007/098080.

Of course, use might also be made of mixtures of the coupling agents described above, as described in particular in the abovementioned Application WO 2006/125534.

When they are reinforced with an inorganic filler, such as silica, the rubber compositions preferably comprise between 2 and 15 phr, more preferably between 3 and 12 phr, of coupling agent.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

4.3. Blowing Agent and Associated Activator

The invention has the essential characteristic of using, in combination, at particularly high contents, sodium carbonate, sodium hydrogencarbonate, potassium carbonate or potassium hydrogencarbonate, as blowing agent, with which is combined, as expansion activator, a carboxylic acid, the melting point of which is between 60° C. and 220° C.

In a well-known way, a blowing agent is a compound which can decompose thermally and which is intended to release, during thermal activation, for example during the vulcanization of the tyre, a large amount of gas and to thus result in the formation of bubbles. The release of gas in the rubber composition thus originates from this thermal decomposition of the blowing agent.

The blowing agent used in accordance with the present invention is sodium carbonate, sodium hydrogencarbonate (sometimes also referred to as bicarbonate), potassium carbonate or potassium hydrogencarbonate. In other words, it is selected from the group consisting of sodium carbonate, sodium hydrogencarbonate, potassium carbonate, potassium hydrogencarbonate and the mixtures of these compounds (including, of course, the hydrated forms).

Such a blowing agent has the advantage of only giving off carbon dioxide and water during its decomposition; it is thus particularly favourable to the environment. Use is made in particular of sodium hydrogencarbonate (NaHCO₃).

The content of this blowing agent is between 5 and 25 phr, preferably between 8 and 20 phr.

Another essential characteristic of the invention is to add, to the blowing agent described above, a carboxylic acid, the melting point of which is between 60° C. and 220° C.

The content of this carboxylic acid is between 2 and 20 phr, preferably between 2 and 15 phr. By dispersing homogeneously in the composition, during the melting thereof within the specific temperature range indicated above, this carboxylic acid has the role of chemically activating (i.e., activating by chemical reaction) the blowing agent which, during its thermal decomposition, will thus release many more bubbles of gas (CO₂ and H₂O) than if it were used alone.

Any carboxylic acid exhibiting a melting point of between 60° C. and 220° C. (thus solid at 23° C.), preferably between 100° C. and 200° C., in particular between 120° C. and 180° C., is capable of being suitable. The melting point is a well-known basic physical constant (available, for example, in “Handbook of Chemistry and Physics”) of organic or inorganic heat-fusible compounds; it can be monitored by any known means, for example by the Thiele method, the Kofler bench method or also by DSC analysis.

The carboxylic acids can be monoacids, diacids or triacids; they can be aliphatic or aromatic; they can also comprise additional functional groups (other than COOH), such as hydroxyl (OH) groups, ketone (C═O) groups or also groups bearing ethylenic unsaturation.

According to a preferred embodiment, the pKa (Ka acidity constant) of the carboxylic acid is greater than 1, more preferably between 2.5 and 12, in particular between 3 and 10.

According to another preferred embodiment, in or not in combination with the preceding embodiment, the carboxylic acid comprises, along its hydrocarbon chain, from 2 to 22 carbon atoms, preferably from 4 to 20 carbon atoms.

The aliphatic monoacids preferably comprise, along their hydrocarbon chain, at least 16 carbon atoms; mention may be made, as examples, of palmitic acid (C₁₆), stearic acid (C₁₈), nonadecanoic acid (C₁₉), behenic acid (C₂₀) and their various mixtures. The aliphatic diacids preferably comprise, along their hydrocarbon chain, from 2 to 10 carbon atoms; mention may be made, as examples, of oxalic acid (C₂), malonic acid (C₃), succinic acid (C₄), glutaric acid (C₅), adipic acid (C₆), pimelic acid (C₇), suberic acid (C₈), azelaic acid (C₉), sebacic acid (C₁₀) and their various mixtures. Mention may be made, as aromatic monoacid, for example, of benzoic acid. The acids comprising functional groups can be monoacids, diacids or triacids of the aliphatic type and of the aromatic type; mention may be made, as examples, of tartaric acid, malic acid, maleic acid, glycolic acid, α-ketoglutaric acid, salicylic acid, phthalic acid or citric acid.

Preferably, the carboxylic acid is selected from the group consisting of palmitic acid, stearic acid, nonadecanoic acid, behenic acid, oxalic acid, malonic acid, succinic acid, glutaric acid, adipic acid, pimelic acid, suberic acid, azelaic acid, sebacic acid, benzoic acid, tartaric acid, malic acid, maleic acid, glycolic acid, a-ketoglutaric acid, salicylic acid, phthalic acid, citric acid or the mixtures of these acids.

More particularly, the carboxylic acid is selected from the group consisting of malic acid, α-ketoglutaric acid, citric acid, stearic acid and their mixtures. More preferably still, citric acid, stearic acid or a mixture of these two is used.

Another essential characteristic of the invention, for the targeted reduction in the running noise, is that the total amount of blowing agent and of its associated activator is greater than 10 phr, preferably between 10 and 40 phr. This total amount is more preferably greater than 15 phr, in particular between 15 and 40 phr.

4.4. Various Additives

The heat-expandable rubber composition can also comprise all or some of the usual additives generally used in rubber compositions for tyre treads, such as, for example, protection agents, such as anti-ozone waxes, chemical antiozonants or antioxidants, plasticizing agents, a crosslinking system based either on sulphur or on sulphur donors and/or on peroxide and/or on bismaleimides, vulcanization accelerators or vulcanization activators.

According to a preferred embodiment, the heat-expandable rubber composition also comprises a liquid plasticizing agent (liquid at 20° C.), the role of which is to soften the matrix by diluting the diene elastomer and the reinforcing filler; its Tg (glass transition temperature) is, by definition, less than −20° C., preferably less than −40° C.

According to another preferred embodiment, this liquid plasticizer is used at a relatively small content, such that the ratio by weight of reinforcing filler to liquid plasticizing agent is greater than 2.0, more preferably greater than 2.5, in particular greater than 3.0.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances which have the ability to eventually assume the shape of their container), in contrast in particular to plasticizing hydrocarbon resins, which are by nature solids at ambient temperature.

Liquid plasticizers selected from the group consisting of naphthenic oils (low- or high-viscosity, in particular hydrogenated or non-hydrogenated), paraffinic oils, MES (Medium Extracted Solvates) oils, DAE (Distillate Aromatic Extracts) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

Mention may be made, as phosphate plasticizers, for example, of those which comprise between 12 and 30 carbon atoms, for example trioctyl phosphate. Mention may in particular be made, as examples of ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may in particular be made, among the above triesters, of glycerol triesters, preferably predominantly composed (for more than 50%, more preferably for more than 80% by weight) of an unsaturated C₁₈ fatty acid, that is to say selected from the group consisting of oleic acid, linoleic acid, linolenic acid and the mixtures of these acids. More preferably, whether it is of synthetic origin or natural origin (case, for example, of sunflower or rapeseed vegetable oils), the fatty acid used is composed for more than 50% by weight, more preferably still for more than 80% by weight, of oleic acid. Such triesters (trioleates) having a high content of oleic acid are well known; they have been described, for example in Application WO 02/088238, as plasticizing agents in tyre treads.

According to another preferred embodiment, the rubber composition of the invention can also comprise, as solid plasticizer (solid at 23° C.), a hydrocarbon resin exhibiting a Tg of greater than +20° C., preferably of greater than +30° C., such as described, for example, in Applications WO 2005/087859, WO 2006/061064 or WO 2007/017060.

Hydrocarbon resins are polymers well-known to a person skilled in the art which are essentially based on carbon and hydrogen and which are thus miscible by nature in diene elastomer compositions, when they are additionally described as “plasticizing”. They can be aliphatic, aromatic or also of the aliphatic/aromatic type, that is to say based on aliphatic and/or aromatic monomers. They can be natural or synthetic, based or not based on petroleum (if such is the case, also known under the name of petroleum resins). They are preferably exclusively of hydrocarbon nature, that is to say that they comprise only carbon and hydrogen atoms.

Preferably, the plasticizing hydrocarbon resin exhibits at least one, more preferably all, of the following characteristics:
a Tg of greater than 20° C. (more preferably between 40 and 100° C.);
a number-average molecular weight (Mn) of between 400 and 2000 g/mol (more preferably between 500 and 1500 g/mol);
a polydispersity index (PI) of less than 3, more preferably of less than 2 (as a reminder: PI=Mw/Mn with Mw the weight-average molecular weight).

The Tg of this resin is measured in a known way by DSC (Differential Scanning Calorimetry) according to Standard ASTM D3418. The macrostructure (Mw, Mn and PI) of the hydrocarbon resin is determined by steric exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

According to a particularly preferred embodiment, the plasticizing hydrocarbon resin is selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Use is more preferably made, among the above copolymer resins, of those selected from the group consisting of (D)CPD/vinylaromatic copolymer resins, (D)CPD/terpene copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins, C₉ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methylstyrene, ortho-, meta- or para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic compound is styrene or a vinylaromatic monomer resulting from a C₉ fraction (or more generally from a C₈ to C₁₀ fraction). Preferably, the vinylaromatic compound is the minor monomer, expressed as molar fraction, in the copolymer under consideration.

The content of hydrocarbon resin is preferably between 3 and 60 phr, more preferably between 3 and 40 phr, in particular between 5 and 30 phr.

In the case where it is desired to increase the stiffness of the tread once blown, without, however, reducing the content of liquid plasticizer above, reinforcing resins (e.g., methylene acceptors and donors), such as described, for example, in WO 02/10269 or U.S. Pat. No. 7,199,175, can advantageously be incorporated.

The heat-expandable rubber composition can also comprise coupling activators, when a coupling agent is used, agents for covering the inorganic filler, when an inorganic filler is used, or more generally processing aids capable, in a known way, by virtue of an improvement in the dispersion of the filler in the rubber matrix and of a lowering of the viscosity of the compositions, of improving their processability in the raw state; these agents are, for example, hydroxysilanes or hydrolysable silanes, such as alkylalkoxysilanes, polyols, polyethers, amines, or hydroxylated or hydrolysable polyorganosiloxanes.

4.5. Manufacture of the Compositions

The rubber compositions are manufactured in appropriate mixers, for example using two successive phases of preparation according to a general procedure known to a person skilled in the art: a first phase of thermomechanical working or kneading (sometimes referred to as “non-productive” phase) at high temperature, up to a maximum temperature of between 130° C. and 200° C., preferably between 145° C. and 185° C., during which in particular the blowing activator (carboxylic acid) is incorporated, followed by a second phase of mechanical working (sometimes referred to as “productive” phase) at low temperature, typically below 120° C., for example between 60° C. and 100° C., during which finishing phase the blowing agent and the crosslinking or vulcanization system are incorporated.

A process which can be used for the manufacture of such rubber compositions comprises, for example and preferably, the following stages:
incorporating, in a mixer, at least the filler and the carboxylic acid in the elastomer or in the mixture of elastomers, everything being kneaded thermomechanically, in one or more goes, until a maximum temperature of between 130° C. and 200° C. is reached;
cooling the combined mixture to a temperature of less than 100° C.;
then incorporating the blowing agent (sodium carbonate, sodium hydrogencarbonate, potassium carbonate or potassium hydrogencarbonate) in the mixture thus obtained and cooled, everything being kneaded thermomechanically until a maximum temperature of less than 100° C. is reached;
subsequently incorporating a crosslinking system;
kneading everything up to a maximum temperature of less than 120° C.;
extruding or calendering the rubber composition thus obtained.

By way of example, all the necessary constituents, the optional supplementary covering agents or processing aids and various other additives, with the exception of the blowing agent and the crosslinking system, are introduced, during the first non-productive phase, into an appropriate mixer, such as an ordinary internal mixer. After thermomechanical working, dropping and cooling of the mixture thus obtained, the blowing agent, then the vulcanization retarder (if such a compound is used) and, finally, the remainder of the vulcanization system (sulphur and accelerator), at low temperature, are then incorporated, preferably in this order, generally in an external mixer, such as an open mill; everything is then mixed (productive phase) for a few minutes, for example between 5 and 15 min.

The crosslinking system proper is preferably based on sulphur and on a primary vulcanization accelerator, in particular on an accelerator of the sulphenamide type. Additional to this vulcanization system are various known secondary vulcanization accelerators or vulcanization activators, such as zinc oxide, stearic acid, guanidine derivatives (in particular diphenylguanidine), and the like, incorporated during the first non-productive phase and/or during the productive phase. The sulphur content is preferably between 0.5 and 5 phr and the content of the primary accelerator is preferably between 0.5 and 8 phr.

Use may be made, as (primary or secondary) accelerator, of any compound capable of acting as accelerator for the vulcanization of diene elastomers in the presence of sulphur, in particular accelerators of the thiazole type, and also their derivatives, and accelerators of thiuram and zinc dithiocarbamate types. These accelerators are, for example, selected from the group consisting of 2-mercaptobenzothiazyl disulphide (abbreviated to “MBTS”), tetrabenzylthiuram disulphide (“TBZTD”), N-cyclohexyl-2-benzothiazolesulphenamide (“CBS”), N,N-dicyclohexyl-2-benzothiazolesulphenamide (“DCBS”), N-(tert-butyl)-2-benzothiazolesulphenamide (“TBBS”), N-(tert-butyl)-2-benzothiazolesulphenimide (“TBSI”), zinc dibenzyldithiocarbamate (“ZBEC”) and the mixtures of these compounds.

As the carboxylic acid has, as possible effect, that of reducing the induction period (that is to say, the time necessary at the start of the vulcanization reaction) during the curing of the composition, a vulcanization retarder, which makes it possible to thwart this phenomenon and to thus provide the rubber composition with the time necessary for complete expansion before the vulcanization thereof, can advantageously be used.

The content of this vulcanization retarder is preferably between 0.5 and 10 phr, more preferably between 1 and 5 phr, in particular between 1 and 3 phr.

Vulcanization retarders are well known to a person skilled in the art. Mention may be made of N-cyclohexylthiophthalimide, sold under the name “Vulkalent G” by Lanxess, N-(trichloromethylthio)benzenesulphonamide, sold under the name “Vulkalent E/C” by Lanxess, or also phthalic anhydride, sold under the name “Vulkalent B/C” by Lanxess. Preferably, N-cyclohexylthiophthalimide (abbreviated to “CTP”) is used.

The final composition thus obtained is subsequently calendered, for example in the form of a sheet or plaque, in particular for laboratory characterization, or else calendered or extruded in the form of a heat-expandable tread.

In the raw state (i.e., non-vulcanized state) and thus non-expanded state, the density, denoted D₁, of the heat-expandable rubber composition is preferably between 1.100 and 1.400 g/cm³, more preferably within a range from 1.150 to 1.350 g/cm³.

The vulcanization (or curing) is carried out in a known way at a temperature generally of between 130° C. and 200° C., for a sufficient time which can vary, for example, between 5 and 90 min, as a function in particular of the curing temperature, of the vulcanization system adopted and of the kinetics of vulcanization of the composition under consideration.

It is during this vulcanization stage that the blowing agent will release a large amount of gas, to result in the formation of bubbles in the foam rubber composition and finally in its expansion.

In the cured state (i.e., vulcanized state), the density, denoted D₂, of the rubber composition once expanded (i.e., in the foam rubber state) is preferably between 0.500 and 1.000 g/cm³, more preferably within a range from 0.600 to 0.850 g/cm³.

Its degree of expansion by volume, denoted T_{E} (expressed as %), is preferaby between 30% and 150%, more preferably within a range from 50% to 120%, this degree of expansion T_{E} being calculated in a known way from the above densities D₁ and D₂, as follows:

T_{E}=[(D₁/D₂)−1]×100.

Preferably, its Shore A hardness (measured in accordance with Standard ASTM D 2240-86) is within a range from 45 to 60.

### 5. EXAMPLES OF THE IMPLEMENTATION OF THE INVENTION

The heat-expandable rubber composition described above can advantageously be used in treads, at least for their portion which is intended to come directly into contact with the surface of the road, of tyres for any type of vehicle, in particular in tyres for passenger vehicles, as demonstrated in the tests which follow.

For the requirements of these tests, two rubber compositions (denoted C-0 and C-1) were prepared, the formulations of which are given in Table 1 (contents of the various products expressed in phr). The composition C-0 is the control composition. The composition C-1 is that in accordance with the invention; it additionally comprises the blowing agent (sodium hydrogencarbonate) and the associated carboxylic acid (citric acid), as well as a vulcanization retarder (CTP).

The following procedure was used for the manufacture of these compositions: the reinforcing filler, the diene elastomer (SBR and BR blend), the carboxylic acid for the C-1 composition and the various other ingredients, with the exception of the vulcanization system and the blowing agent, were successively introduced into an internal mixer, the initial vessel temperature of which was approximately 60° C.; the mixer was thus filled to approximately 70% (% by volume). Thermomechanical working (non-productive phase) was then carried out in a stage of approximately 2 to 4 min, until a maximum “dropping” temperature of approximately 150° C. was reached. The mixture thus obtained was recovered and cooled to approximately 50° C. and then the blowing agent (sodium hydrogencarbonate), the vulcanization retarder (CTP), followed by the sulphenamide accelerator and the sulphur were incorporated on an external mixer (homofinisher) at 30° C., everything being mixed (productive phase) for a few minutes.

The compositions C-0 and C-1 thus prepared were subsequently vulcanized under a press, and their properties were measured before and after curing (see appended Table 2).

The rubber composition according to the invention exhibits, after curing, once in the foam rubber state (i.e., expanded state), a markedly reduced density corresponding to a particularly high degree of expansion by volume of approximately 70%. Such an expansion capacity confers improved sound barrier properties on it capable of contributing to reducing the noise emitted both inside and outside the vehicles during the rolling of their tyres.

Subsequent to these first tests, other rubber compositions, denoted C-2 and C-3, were prepared which are intended to be used as treads of radial carcass passenger vehicle tyres, respectively denoted T-2 (control tyres) and T-3 (tyres in accordance with the invention), these tyres being conventionally manufactured and in all respects identical apart from the constituent rubber compositions of their treads. The formulations (contents in phr) of these two compositions are given in Table 3; their properties were measured before and after curing (Table 4): the rubber composition of the tread of the tyre according to the invention exhibits, after curing, once in the foam rubber state (i.e., expanded state), a very markedly reduced density corresponding to a particularly high degree of expansion by volume of approximately 74%.

In order to subsequently characterize the noise reduction properties of the treads, a running test was carried out on the tyres in which the sound level emitted by the tyres was evaluated by measuring the acoustic pressure level, during running of the vehicle at a speed of 60 km/h, by virtue of several microphones positioned inside the vehicle (road noise) The vehicle used was a vehicle of “Subaru” make (“R1” model); the surface of the roadway used for this test corresponds to a semi-rough asphalt; during passage through the measurement region, recording of the acoustic pressure is triggered.

The results in Table 5 express the difference in sound level recorded between the tyres T-3 according to the invention and the control tyres T-2, within a frequency range from 300 to 1900 Hz These differences are expressed in acoustic energy (dB(A)), which corresponds to the integration of the acoustic pressure as a function of the frequency over the frequency ranges under consideration, a negative value indicating a reduction in the noise with respect to the reference (tyres T-2).

On reading Table 5, it is found that a reduction in noise significant to a person skilled in the art is obtained on the tyres in accordance with the invention by virtue of the specific foam rubber composition constituting their tread.

TABLE 1

Composition No.:

| | C-0 | C-1 |
|---|---|---|
| SBR (1) | 70 | 70 |
| BR (2) | 30 | 30 |
| Silica (3) | 80 | 80 |
| Coupling agent (4) | 6.4 | 6.4 |
| Carbon black (5) | 5 | 5 |
| Blowing agent (6) | — | 16 |
| Expansion activator (7) | — | 8.5 |
| Liquid plasticizer (8) | 15 | 15 |
| Plasticizing resin (9) | 20 | 20 |
| DPG (10) | 1.5 | 1.5 |
| ZnO | 1.2 | 1.2 |
| Stearic acid | 2 | 2 |
| Antiozone wax | 1.5 | 1.5 |
| Antioxidant (11) | 2 | 2 |
| Sulphur | 1.2 | 1.2 |
| Accelerator (12) | 1.8 | 1.8 |
| Retarder (13) | — | 1.0 |

(1) SBR with 26% of styrene units and 74% of butadiene units (21% of trans-1,4-, 21% of cis-1,4- and 58% of 1,2-); Tg = −25° C.;
(2) BR with 0.3% of 1,2-; 2.7% of trans; 97% of cis-1,4-(Tg = −104° C.);
(3) Silica, Ultrasil 7000 from Degussa, HDS type (BET and CTAB: approximately 160 m²/g);
(4) TESPT coupling agent (Si69 from Degussa);
(5) ASTM grade N234 (Cabot);
(6) Sodiun hydrogencarbonate (Cellmic C266 from Sankyo Kasei);
(7) Citric acid (Kanto Kagaku);
(8) MES oil (Catenex SNR from Shell);
(9) C₅/C₉ resin (Escorez ECR-373 from Exxon);
(10) Diphenylguanidine (Perkacit DPG from Flexsys);
(11) N-(1,3-Dimethylbutyl)-N-phenyl-para-phenylenediamine (Santoflex 6-PPD from Flexsys);
(12) N-Dicyclohexyl-2-benzothiazolesulphenamide (Santocure CBS from Flexsys);
(13) Cyclohexylthiophthalimide (Vulkalent G from Lanxess).

TABLE 2

Composition
tested:

| | C-0 | C-1 |
|---|---|---|
| Shore A hardness | 65 | 50 |
| Density before curing the tyre | 1.17 | 1.18 |
| Density after curing the tyre | 1.17 | 0.69 |
| Degree of expansion by volume (%) | 0 | 70 |

TABLE 3

Composition No.:

| | C-2 | C-3 |
|---|---|---|
| SBR (1) | 70 | 70 |
| BR (2) | 30 | 30 |
| Silica (3) | 80 | 80 |
| Coupling agent (4) | 6.4 | 6.4 |
| Carbon black (5) | 5 | 5 |
| Blowing agent (6) | — | 17 |
| Expansion activator (7) | — | 7 |
| Liquid plasticizer (8) | 10 | 10 |
| Plasticizing resin (9) | 20 | 20 |
| DPG (10) | 1.5 | 1.5 |
| ZnO | 1.2 | 1.2 |
| Stearic acid | 2 | 2 |
| Antiozone wax | 1.5 | 1.5 |
| Antioxidant (11) | 2 | 2 |
| Sulphur | 1.2 | 1.2 |
| Accelerator (12) | 2.5 | 2.5 |
| Retarder (13) | — | 2.5 |

(1) to (13): idem Table 1

TABLE 4

Composition
tested:

| | C-2 | C-3 |
|---|---|---|
| Shore A hardness (measured on tyre): | 65 | 50 |
| Density before curing the tyre | 1.17 | 1.20 |
| Density after curing the tyre | 1.17 | 0.69 |
| Degree of expansion by volume (%) | 0 | 74 |

TABLE 5

Range (Hz)

| | 300-700 | 700-1100 | 1100-1500 | 1500-1900 |
|---|---|---|---|---|
| dB(A) (*) | −0.5 | −0.6 | −0.9 | −1.1 |

(*) difference between tyre of the invention and control tyre, inside the vehicle

1-24. (canceled)

25. A tyre comprising a tread,
wherein the tread, in a unvulcanized state, includes a heat-expandable rubber composition,
wherein the rubber composition includes:
from 50 to 100 phr of a copolymer based on styrene and butadiene;
optionally from 0 to 50 phr of another diene elastomer;
more than 50 phr of a reinforcing filler;
between 5 and 25 phr of sodium carbonate, sodium hydrogencarbonate, potassium carbonate, or potassium hydrogencarbonate;
between 2 and 15 phr of a carboxylic acid having a melting point between 60° C. and 220° C., and
wherein a total content of the carboxylic acid and the carbonate or the hydrogencarbonate is greater than 10 phr.

26. The tyre according to claim 25, wherein the copolymer based on styrene and butadiene is selected from a group of copolymers consisting of: styrene/butadiene copolymers, styrene/butadiene/isoprene copolymers, and mixtures thereof.

27. The tyre according to claim 26, wherein the copolymer based on styrene and butadiene is a styrene/butadiene copolymer.

28. The tyre according to claim 25, wherein the copolymer based on styrene and butadiene exhibits a glass transition temperature that is greater than −40° C.

29. The tyre according to claim 25, wherein the other diene elastomer is selected from a group of elastomers consisting of: natural rubber, synthetic polyisoprenes, polybutadienes, butadiene copolymers, isoprene copolymers, and mixtures thereof.

30. The tyre according to claim 29, wherein the other diene elastomer is a polybutadiene having a content of cis-1,4-bonds of greater than 90%.

31. The tyre according to claim 29, wherein the other diene elastomer is a natural rubber or a synthetic polyisoprene.

32. The tyre according to claim 29, wherein the other diene elastomer is a polybutadiene in a mixture with a natural rubber or a synthetic polyisoprene.

33. The tyre according to claim 25, wherein the reinforcing filler includes an inorganic filler, carbon black, or a mixture of inorganic filler and carbon black.

34. The tyre according to claim 25, wherein the reinforcing filler is present at a content of between 50 and 150 phr.

35. The tyre according to claim 25, wherein the rubber composition includes a plasticizing agent that is a liquid at 20° C., the plasticizing agent being present at a content such that a ratio by weight of the reinforcing filler to the liquid plasticizing agent is greater than 2.0.

36. The tyre according to claim 25, wherein the carbonate or the hydrogencarbonate is present at a content of between 8 and 20 phr.

37. The tyre according to claim 25, wherein the carboxylic acid is present at a content of between 2 and 15 phr.

38. The tyre according to claim 25, wherein the total content of the carboxylic acid and the carbonate or the hydrogencarbonate is greater than 15 phr.

39. The tyre according to claim 25, wherein the melting point of the carboxylic acid is between 100° C. and 200° C.

40. The tyre according to claim 25, wherein a pKa of the carboxylic acid is greater than 1.

41. The tyre according to claim 25, wherein the carboxylic acid includes, along a hydrocarbon chain thereof, from 2 to 22 carbon atoms.

42. The tyre according to claim 41, wherein the carboxylic acid is selected from a group of acids consisting of: palmitic acid, stearic acid, nonadecanoic acid, behenic acid, oxalic acid, malonic acid, succinic acid, glutaric acid, adipic acid, pimelic acid, suberic acid, azelaic acid, sebacic acid, benzoic acid, tartaric acid, malic acid, maleic acid, glycolic acid, α-ketoglutaric acid, salicylic acid, phthalic acid, citric acid, and mixtures thereof.

43. The tyre according to claim 42, wherein the carboxylic acid is selected from a group of acids consisting of: malic acid, α-ketoglutaric acid, citric acid, stearic acid, and mixtures thereof.

44. The tyre according to claim 25, wherein the rubber composition includes a vulcanization retarder.

45. The tyre according to claim 25, wherein a density of the rubber composition, when in the unvulcanized state, is between 1.100 and 1.400 g/cm³.

46. The tyre according to claim 25, wherein the tyre is cured to a vulcanized state in which the rubber composition is expanded.

47. The tyre according to claim 46, wherein a density of the rubber composition, when expanded, is between 0.500 and 1.000 g/cm³.

48. The tyre according to claim 46, wherein a degree of expansion by volume of the rubber composition, when expanded, is between 30% and 150%.
